(19) United States
(12) Patent Application Publication
(10) Pub. No.: US 2008/0245315 A1
(43) Pub. Date: Oct. 9, 2008

(54) PESTICIDAL COLLAR WITH INTEGRATED COVER

(76) Inventor: Michael R. Tyler, Piscataway, NJ (US)

Correspondence Address: STROOCK & STROOCK & LAVAN LLP, 180 MAIDEN LANE, NEW YORK, NY, 10038, US

(21) Appl. No.: 12/098,270

(22) Filed: Apr. 4, 2008

Related U.S. Application Data
(60) Provisional application No. 60/910,406, filed on Apr. 5, 2007.

(51) Int. Cl. A61D 7/00; A01K 29/00

(52) U.S. Cl. 119/654

(57) ABSTRACT

A multilayer laminated collar design provides exceptionally good protection against undesirable contact with the pesticide-bearing surface, together with suitably effective pesticidal activity. The insecticidal animal collar is formed by covering a flexible pesticidal strip component with a top cover layer that is impermeable to the pesticide. When secured around the animal, such laminated arrangement help present pesticide residue from being present on the surface of the collar that is likely to come into contact with humans, furniture, or other animals.

This non-provisional utility patent application claims priority to and the benefit of U.S. provisional application No. 60/910,406, filed Apr. 5, 2007, the contents of which is incorporated herein by reference.

### BACKGROUND OF THE INVENTION

This invention relates to insecticidal collars for animals, and more particularly relates to a flea and tick collar for protecting domestic animals in a setting whereby humans or other animals may come into contact with the collar.

Insecticidal collars are well known in the art. An insecticidal animal collar is generally manufactured from a strip of flexible material, impregnated with insecticide, and attached with buckles, locks, Velcro, or other means of securing the ends of the strip together around the animal. When worn around the neck of the animal, the insecticidal strip comes in contact with the hair of the animal and the insecticide slowly migrates from the strip onto the hair of the animal. Numerous variations exist to account for different purposes.

U.S. Pat. No. 3,944,662, incorporated by reference, describes one particularly effective collar containing the pesticidally active ingredient .beta.-2-chloro-1-(2,4,5-trichlorophenyl)-vinyl dimethyl phosphate (“Rabon”) dispersed in a collar consisting of a matrix of a plasticized thermoplastic resin. (the “Rabon” collar”). The active ingredient is storage safe. When activated by disturbing the collar through rubbing, wiping, or stretching, the active ingredient migrates to the surface of the resin material in a specified pesticidally effective crystalline form. Such collar is storage stable, slow releasing, and non-volatile.

However, there is an unsolved need for cost-effective insecticidal collars that minimizes undesirable contact between humans or other animals with the pesticide-bearing surface. The typical flea collar contains a single strip of material. When secured around the animal, the exposed surface of the insecticidal strip may come into contact with humans and other animals or surfaces, thereby unintentionally transferring the insecticidal agent and creating a safety concern. For example, the active ingredient of the Rabon collar migrants to both surfaces of the collar, thereby exposing anyone who comes into contact with the collar with residues of the active ingredient.

The existing flea collar designs do not adequately address this safety issue. For example, the flea collars described in U.S. Pat. No. 5,555,848 and U.S. Pat. No. 4,224,901, both incorporated by reference, disclose pet collars containing compartments to contain a pesticidal strip. However, in order to use these strips, the pet owner must remove the pesticidal strip from a package, and then physically insert the pesticidal strip into the collar before securing the collar onto the animal. The manipulation of these strips forces pet owners to come into contact with the pesticide and exasperates the problem of exposing the consumer to pesticidal ingredients.

U.S. Pat. No. 5,271,354 and U.S. Pat. No. 4,350,122, both incorporated by reference, discloses flea collars with hollow center or internal passageways containing pesticides. Such collars are less pesticidally effective because they require that the insect travel up the pet's body and into the collar to be killed, while a conventional pesticidal collar is capable of releasing insecticide directly onto the animal. In practice, the steps to manufacture a collar with internal passageways are more costly and time consuming than the conventional pesticidal collar.

U.S. Pat. No. 4,803,956, incorporated by reference, describes a collar containing a plastic barrier layer, manufactured through the process of coextrusion. However, the same pesticides capable of diffusing from the center of the polymeric layer would be expected to migrate through the co-extruded plastic barrier layer to the external surface of the plastic, ultimately causing exposure to consumers.

Thus, none of the existing collars solves the problem of preventing undesirable contact between humans or other animals with the pesticide-bearing surface.

### SUMMARY OF THE INVENTION

Generally speaking, in accordance with the invention, a multilayer laminated collar design provides exceptionally good protection against undesirable contact with the pesticide-bearing surface, together with suitably effective pesticidal activity. In the present invention, an insecticidal animal collar is formed by covering a flexible pesticidal strip component with a top cover layer that is impermeable to the pesticide. When secured around the animal, such laminated arrangement help present pesticide residue from being present on the surface of the collar that is likely to come into contact with humans, furniture, or other animals.

The invention describes preparing collars with an integrated barrier that shields the insecticidal strip from accidental exposure to humans, animals, and unintended surfaces when the collar is worn around the animal. Thus, the barrier is advantageously made of a material impermeable to the insecticide. Furthermore, the barrier should be attributed to the insecticidal strip with sufficient strength and flexibility to prevent any separation or peeling away over the lifetime of the collar, despite repeated deformation of the collar.

It is an additional advantage of the invention to provide an insecticidal collar with an integrated barrier without resorting to complex manufacturing steps of making hollow structures or coextrusion.

Other objects and features of the present invention will become apparent from the following detailed description, considered in conjunction with the accompanying drawing figures. It is to be understood, however, that the drawings are designed solely for the purpose of illustration and not as a definition of the limits of the invention.

### BRIEF DESCRIPTION OF THE FIGURES

For a fuller understanding of the invention, reference is had to the following description, taken in connection with the accompanying drawings, in which:

FIG. 1 is a perspective view of a pesticidal collar in accordance with an embodiment of the invention; and

FIG. 2 is a cross-sectional view a pesticidal collar in accordance with an embodiment of the invention.

### DETAILED DESCRIPTION

A pesticidal strip component in accordance with the invention can be manufactured via known methods such as through an extrusion process from a mixture of a pesticidal active ingredient and a polymeric resin. A pesticide that can maintain its effectiveness through the extrusion process is preferred. A top covering impermeable to the pesticide is applied over the entire top surface of the collar, preferred by laminating a film using heat or pressure sensitive adhesives. The adhesives should be flexible and strong enough to prevent de-lamination as the collar is curved, straightened, stretched and otherwise deformed. Collars that are activated by stretching the pesticidal strip to initiate the migration of pesticide to the surface thereof are preferred. Thus, the adhesive and top layer must be able to remain adhered to the collar even after several percent (e.g. 1-3% and even over 5%) elongation.

The top covering should permit sufficient stretching to withstand the force of rubbing, wiping, or stretching during collar activation, the manipulation as the collar is placed around the neck of the animal, and the stretch and strain when the collar is worn. In a preferred embodiment, the attached top covering can at least withstand the force required to stretch it to at least about 1%, preferably at least up to about 3%, and most preferably, over 5% straight length elongation of its original length without delaminating or breaking.

The size of the pesticidal strip in accordance with the invention can have a width and thickness sufficient to carry pesticidal active ingredient and retain mechanical integrity without restricting the movement of the animal or causing discomfort when worn. The width is preferably in the range between 0.3 inch and 0.6 inch, and preferably between 0.44 and 0.46 inch for a standard collar and 0.58 to 0.59 inch for a wide collar. The thickness is in the range between 0.1 inch and 0.2 inch, and preferably between 0.15 inch and 0.16 inch.

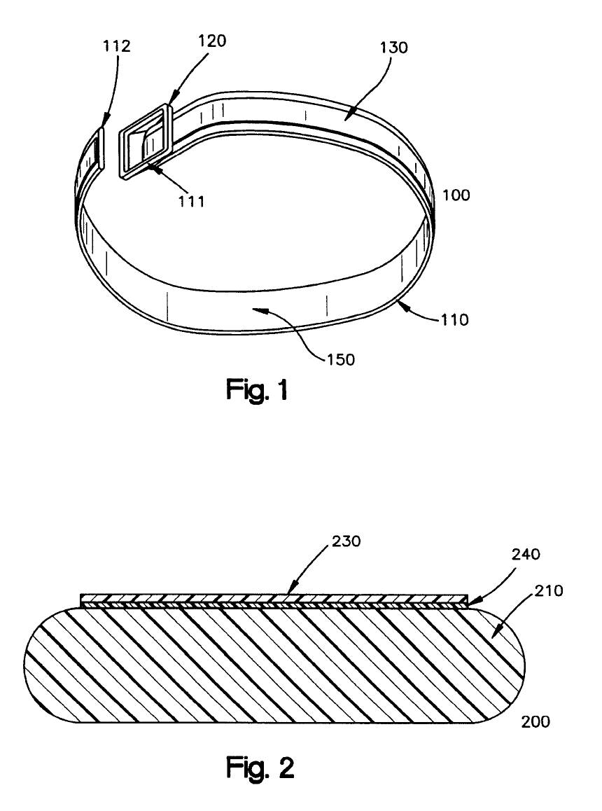

An embodiment of a collar produced in accordance with the present invention is shown in FIG. 1. The collar 100, generally indicated in FIG. 1 contains a main belt portion 110, with a means of securing the collar around the neck of the animal such as a feed-through buckle 120 fixed to a first end 111 and into which a second end 112 is threaded, pulled through, adjusted for fit and pulled tight to secure collar around an animal. It should be appreciated that other forms of securement such as Velcro, hooks, and snaps and the like may be used instead of a belt and a buckle. The present invention is not limited to the selection of the securing mechanisms presented herein. A cover layer 130 extends from the first end 111 to the second end 112 over the outer length of the main belt portion 110 when the main belt portion 110 is secured around the animal. An inner surface 150 of main belt portion 110 is not covered, thereby permitting the migration of the pesticide to the inner surface of the collar.

FIG. 2 represents the cross-section of a main belt portion 200 of an embodiment of the present invention. Main belt portion 200 is comprised of a pesticidal strip component 210. Strip 210 can be prepared by incorporating into a plasticized thermoplastic resin a pesticidally active ingredient such as .beta-2-chloro-1-2-chloro-1-(2,4,5-trichlorophenyl)-vinyl dimethyl phosphate (“Rabon”), S-methoprene, Pyriproxfen, Propoxur, Naled, Deltramethrin, Tetramethrin, Permethrin, Phenothrin, Prallethrin, Cyphenthothrin, Amitraz, Tralomethrin, Etofenprox, Fenvalerate or Allethrin. Any resin capable of releasing pesticidally effective amounts of the active ingredient and sufficiently flexible to be used as an animal collar is appropriate, including ethylene vinyl acetate copolymers, natural rubbers, copolyesters, styrene copolymers, olefin elastomers or elastomeric alloys, and preferably polyvinyl chloride (PVC) and copolymer and combinations thereof.

The plasticizers which may be used are those conventionally used in the plasticization of thermoplastic resins, including but not limited to phthalates-such as di(2-ethylhexyl), diisooctyl, diisononyl; adipates such as dioctyl, dicapryl, diisobutyl; sebacates such as dibutyl, or malalates such as dicapryl, dioctyl, dibutyl, azelates such as dioctyl.

A top cover layer 230 extends substantively along the entire length of the belt portion 200 and is substantively co-extensive with pesticidal strip 210. Top cover layer 230 may include any material impermeable and inert to the active ingredient, sufficiently flexible and stretchy to withstand the mechanical manipulation of conventional flea collar use, such as multilayer plastic laminates made with polyurethanes, polyethylenes, polypropylenes or other suitable material. The top cover layer may contain additional characteristics suitable for a flea collar such aesthetics pleasing color or design or reflexivity to enhance the visibility and safety of the pet.

An adhesive layer 240 can be used to adhere cover layer 230 to pesticide strip 210. Top cover layer 230 should remain fixed to pesticidal strip component 210. An adhesive applied between top cover layer and pesticidal strip 210 ensure that the two layers remain attached throughout the useful lifetime (e.g., six to seven months) of the pesticidal collar, subject to the mechanical stress associated with normal usage.

In one preferred embodiment of the invention, the pesticidal strip component is first prepared as a dry blend containing PVC resin, plasticizers, stabilizers, and other additives. The dry blend is mixed in a mixer at 180° F. The blend is subsequently combined with the Rabon insecticide in a cooler mixer with the insecticide and loaded into a thermoplastic extruder, melted, and extruded thru a die into a strand.

In one preferred embodiment of the invention, the top cover layer, with adhesive, is supplied by Minnesota Mining and Manufacturing Company (“3M”) and marketed under the trademark Scotchlite Reflective Material—8710 Silver Transfer Film. In another preferred embodiment, the top cover layer with adhesive is supplied by 3M and marketed under the trademark Scotchlite Reflective Material—8765 White Transfer Film. These materials are supplied as a flexible multilayer laminated strip made with retroreflective glass lenses seated in a beadbond compound bonded to a heat activated polyurethane adhesive, with a printed clear plastic liner to cover and protects the adhesive side.

In one preferred method of securing, the top cover layer to the pesticidal strip component, the 8710 Silver Transfer Film or 8765 White Transfer Film is cut into a roll the width of the extruded pesticidal strand. The plastic liner is then removed to expose the dry adhesive. The 8710 Silver Transfer Film or 8765 White Transfer Film is then placed on the pesticidal strand, adhesive side down. The 8710 Silver Transfer Film or 8765 White Transfer Film is then fixed to the pesticidal strand by being compressed between two moving Teflon belts while being heated. A preferred heat fixing temperature for this material is set between 325° F. (165° C.) and 375° F. (190° C.), and most preferably at 356° F. (180° C.). The preferred heat fixing time is set between 2 and 10 seconds, and most preferably at 3 seconds. The strip is cooled at room temperature, cut to length, and attached with a buckle.

Other products form 3M that are suitable cover layers include Scotchlite 8789 Fluorescent Red-orange Transfer Film and 8787 Fluorescent Lime-yellow Transfer Film, Scotchlite 9720 Silver Industrial Wash Transfer Film and Scotchlite 8725 Silver Transfer Film. These films are similar to the 3M 8710 and 3M 8765 films except a polyester heat activated adhesive is used.

### EXAMPLE I

Two samples of insecticide-containing collars were prepared. Collar I and II were extruded using a 15% Rabon™ Collar dry blend. Collar I was extruded to be 0.440 inch wide by 0.158 inch thick. Collar II was extruded to be 0.593 inch wide by 0.150 inch thick. A half-inch wide strip of 3M 8710 Silver Transfer film was fixed to the center of the top surface of Collar II for the full length. A foot long piece of Collar I and a foot long piece of Collar II were tested for release of Rabon using a Wipe & Weigh Test. Wipe & Weigh testing allows for the comparison of a known effective “Hartz® 2in1 Flea & Tick Collar” (Collar I) and the “Pesticidal Collar with Intergraded Cover” (Collar II). Similar collar efficacy is implied by similar Rabon release rates in the Wipe & Weigh Test.

The effectiveness of the collar compared to a coverless collar is shown in Table 1.

TABLE 1

| | 3 Month Wipe & Weigh Test | |
|---|---|---|
| | Release rate = gm of Rabon per foot of collar* | |
| | | Collar II |
| | Collar I | (Pesticidal |
| Days | (Hartz ® 2in1 Flea& Tick Collar) | Collar with Integrated Cover) |
| 0 | 0.005 | 0.021 |
| 1 | 0.067 | 0.062 |
| 2 | 0.134 | 0.122 |
| 3 | 0.194 | 0.172 |
| 6 | 0.276 | 0.253 |
| 7 | 0.341 | 0.303 |
| 8 | 0.386 | 0.336 |
| 10 | 0.447 | 0.392 |
| 14 | 0.528 | 0.480 |
| 21 | 0.626 | 0.578 |
| 28 | 0.734 | 0.679 |
| 35 | 0.835 | 0.791 |
| 42 | 0.938 | 0.903 |
| 49 | 1.020 | 0.985 |
| 56 | 1.109 | 1.090 |
| 65 | 1.206 | 1.189 |
| 72 | 1.271 | 1.292 |
| 85 | 1.402 | 1.443 |
| 93 | 1.465 | 1.540 |

*Sample strip wiped at each test point, with soft paper wiper until weight is constant.

### EXAMPLE 2

Four additional insecticide-containing collars were prepared in a similar manner to Example 1. Collar III, a control sample, is a commercially available Hartz® 2in1 profile collar. Collar IV, an embodiment of the invention, is a Wide profile collar with a 3M 8710 Silver Film cover. Collar V, another embodiment of the invention, in a Wide profile collar with 3M 8765 White Film cover. Collar VI, a control sample, is a Wide profile collar without cover. Wide collar profile is 0.588 inch wide by 0.127 inch thick.

The main belt portion of Collars III-VI are made from a flea collar dry blend containing the active ingredients of 1% Methoprene and 15% Rabon.

Wipe & Weigh testing was done in the same manner as Example 1 continuing for seven months. The shielding effect of the 3M 8710 and 8765 film covers is seen when the release rate of unshielded Collar VI is compared to Collars IV and V, both of which include an integrated cover. The Rabon release rates for Collars IV and V are similar to that of Collar III (Hartz® 2in1 collar profile). Test results are shown in Table 2.

TABLE 2

| | 7 Month Wipe & Weigh Test* | | | |
|---|---|---|---|---|
| | Release rate = gm of Rabon/ft of Collar | | | |
| | | Collar IV | Collar V | |
| | Collar III | (with 3M | (with 3M | Collar VI |
| | (Hartz ® 2 in 1 | 8710 Silver | 8765 White | (3 in 1 Profile |
| Days | Profile | Film cover) | Film cover) | without Cover) |
| 0 | 0.021 | 0.024 | 0.016 | 0.022 |
| 2 | 0.191 | 0.168 | 0.163 | 0.291 |
| 7 | 0.495 | 0.445 | 0.446 | 0.709 |
| 21 | 0.846 | 0.777 | 0.774 | 1.156 |
| 37 | 1.169 | 1.084 | 1.058 | 1.552 |
| 49 | 1.379 | 1.307 | 1.242 | 1.772 |
| 62 | 1.542 | 1.473 | 1.387 | 1.906 |
| 79 | 1.673 | 1.626 | 1.524 | 1.992 |
| 100 | 1.757 | 1.747 | 1.639 | 2.040 |
| 114 | 1.792 | 1.802 | 1.695 | 2.056 |
| 128 | 1.818 | 1.848 | 1.745 | 2.071 |
| 135 | 1.828 | 1.869 | 1.764 | 2.077 |
| 142 | 1.841 | 1.888 | 1.784 | 2.089 |
| 154 | 1.854 | 1.912 | 1.812 | 2.101 |
| 176 | 1.878 | 1.950 | 1.851 | 2.119 |
| 198 | 1.925 | 2.005 | 1.908 | 2.165 |

*Sample strip wiped at each test point, with soft paper wiper until weight is constant.

The examples provided are merely exemplary, as a matter of application specific to design choice, and should not be construed to limit the scope of the invention in any way.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. A pesticidal animal collar comprising:
a multilayer assembly sized and constructed to be worn around the neck of an animal, including a polymeric matrix layer having a top and bottom surface containing at least one insecticide in a paracidicially effective amount, a cover layer substantively impermeable and inert to said insecticide; the cover layer fixed to the top surface of the polymeric matrix.

2. The collar of claim 1, wherein the insecticide comprises .beta.-2-chloro-1-2-chloro-1-(2,4,5-trichlorophenyl)-vinyl dimethyl phosphate.

3. The collar of claim 2, wherein the polymeric matrix comprises at least one thermoplastic resin selected from the group consisting of ethylene vinyl acetate copolymers, natural rubbers, copolyesters, styrene copolymers, olefin elastomers, elastomeric alloys, and combinations thereof.

4. The collar of claim 2, wherein the polymeric matrix comprises of polyvinyl chloride plastic.

5. The collar of claim 1, wherein the cover layer comprises polyurethane.

6. The collar of claim 1, wherein the cover layer comprises polyethylene.

7. The collar of claim 1, wherein the cover layer comprises polypropylene.

8. The collar of claim 1, wherein the cover layer further comprising glass lenses seated in a beadbond compound bonded to a heat activated polyurethane adhesive.

9. The collar of claim 1, wherein the heat activated polyurethane adhesive is selected from the group of non-reactive or reactive polyurethane adhesives.

10. The collar of claim 1, the collar having a width between 0.3 inch and 0.6 inch.

11. The collar of claim 1, the collar having a thickness between 0.1 inch and 0.2 inch.

12. The collar of claim 1, wherein the collar can at least withstand the force required to stretch the collar to about 1% elongation of its original length without delaminating or breaking the collar.

13. The collar of claim 1, wherein the collar can at least withstand the force required to stretch the collar to about 3% elongation of its original length without delaminating or breaking the collar.

14. The collar of claim 1, wherein the collar can at least withstand the force required to stretch the collar to about 5% elongation of its original length without delaminating or breaking the collar.
